(19) United States
(12) Patent Application Publication
(10) Pub. No.: US 2011/0135073 A1
(43) Pub. Date: Jun. 9, 2011

(54) METHODS TO IMPROVE FRAUD DETECTION ON CONFERENCE CALLING SYSTEMS BY DETECTION OF CONFERENCE MODERATOR PASSWORD UTILIZATION FROM A NON-AUTHORIZED DEVICE

(76) Inventors: Charles Steven Lingafelt, Durham, NC (US); James William Murray, Research Triangle Park, NC (US); James Thomas Swantek, Canton, GA (US)

(21) Appl. No.: 12/631,408

(22) Filed: Dec. 4, 2009

(51) Int. Cl. H04M 11/00

(52) U.S. Cl. 379/93.02

(57) ABSTRACT

An embodiment of the invention includes a method for detecting fraudulent use in a conference calling system. An authorized device registry is created in an electronic database, wherein the authorized device registry identifies one or more authorized devices permitted to access the conference calling system. A request to access the conference calling system is received from a device; and, a processor determines whether the device is included in the authorized device registry. If the device is included in the authorized device registry, the device is granted access to the conference calling system. If the device is not included in the authorized device registry, however, are performed by the processor.

### BACKGROUND

The present invention is in the field of methods, systems, and computer program products to improve fraud detection on conference calling systems by detection of conference moderator passcode utilization from a non-authorized device.

A conference call (also known as a “teleconference” or a “teleconference call”) is a telephone call in which the calling party wishes to have more than one called party participate in the audio portion of the call. The conference call may be designed to allow the called party to participate during the call, or the call may be set up so that the called party merely listens into the call and cannot speak. It is often referred to as an ATC (Audio Tele-Conference). In addition to audio, conference calls can include video, multimedia and other communication methods.

Conference calls can be designed so that the calling party calls the other participants and adds them to the call; however, participants are usually able to call into the conference call without assistance from an “operator” of the conference system, by dialing into a special telephone number that connects to a “conference bridge” (a specialized type of equipment that links telephone lines).

Companies commonly use a specialized service provider who maintains the conference bridge, or who provides the phone numbers and PIN codes that participants dial to

### SUMMARY

An embodiment of the invention includes a method for detecting fraudulent use in a conference calling system. An authorized device registry is created in an electronic database, wherein the authorized device registry identifies one or more authorized devices permitted to access the conference calling system. In at least one embodiment, the authorized device registry also includes the device identification numbers of the authorized devices. In at least one embodiment, the telephone number associated with an authorized device is obtained via a caller-identification system when the authorized device contacts the conference calling system. In another embodiment, information regarding an authorized device is obtained from a subscriber identity module (SIM) card of the authorized device, a moderator of the conference calling system, and/or an administrator of the conference calling system.

A request to access the conference calling system is received from a device. In at least one embodiment, the request to access the conference calling system includes either a moderator or participant passcode. In at least one embodiment, user information is obtained from the person assigned the passcode. The user information includes an employee number, an identification badge number, a home telephone number, a home address, a mobile telephone number, an e-mail address, an office telephone number, an office address, and/or answer(s) to security question(s) entered by the person assigned the passcode. In another embodiment, an identification number is obtained from the device (also referred to herein as the “call-in device identification number”).

A processor determines whether the device is included in the authorized device registry. In at least one embodiment, the processor determines whether the call-in device identification number of the device matches the authorized device identification number of an authorized device. If the device is included in the authorized device registry, the device is granted access to the conference calling system. If the device is not included in the authorized device registry, however, actions are performed by the processor.

In at least one embodiment, devices having the call-in device identification number of a device not listed in the authorized device registry are barred from accessing the conference calling system. In another embodiment, validation information is obtained from the person requesting access to the conference calling system from the device. The user information is compared to the validation information to determine whether the user information matches the validation information. If the user information does not match the validation information, an alert indicating that an unauthorized device has requested access to the conference calling system is sent to the person assigned the passcode. In at least one embodiment, the alert is also sent to an administrator of the conference calling system, participants of the conference call, and/or a security personnel.

In at least one embodiment, further actions include allowing the administrator to enter the conference call, terminating the conference call, voiding the passcode, and barring the device from access to the conference calling system. In another embodiment, a report is generated and stored if the device is not included in the authorized device registry. The report includes the passcode, the total number of passcodes entered into the conference calling system, the total number of moderator passcodes entered into the conference calling system, the time and date when the request to access the conference calling system was received, the call-in device identification number of the device, authorized device identification numbers, and/or the actions performed (including the user and validation information).

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a conference calling system according to embodiment of the invention;

FIG. 2 is a flow diagram illustrating a preparation phase according to an embodiment of the invention;

FIG. 3 is a flow diagram illustrating a method for determining whether a passcode was entered from a pre-registered device according to an embodiment of the invention;

FIG. 4 is a flow diagram illustrating a method for performing response actions according to an embodiment of the invention;

FIG. 5 is a flow diagram illustrating a method for detecting fraudulent use of a passcode in a conference calling system according to an embodiment of the invention;

FIG. 6 illustrates a system for detecting fraudulent use of a passcode in a conference calling system according to an embodiment of the invention; and

FIG. 7 illustrates a computer program product according to an embodiment of the invention.

### DETAILED DESCRIPTION

Exemplary, non-limiting embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

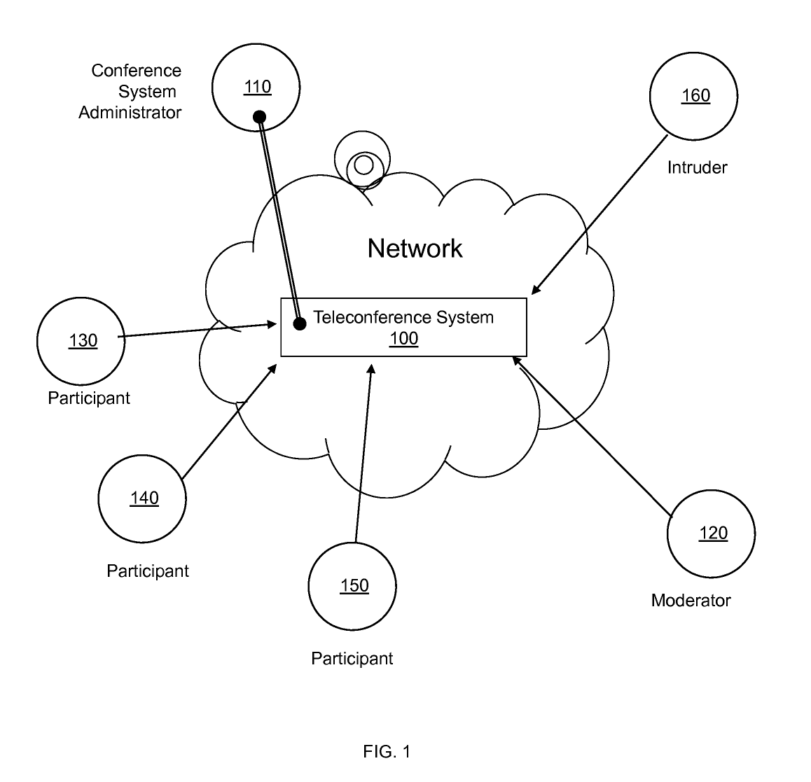

FIG. 1 illustrates a conference calling system (also known as a teleconference system) 100 according to embodiment of the invention, wherein a conference system administrator 110, conference moderator 120, participants 130, 140, and 150, and unauthorized intruder 160 are connected to the conference calling system 100. The conference moderator 120, participants 130, 140, and 150, and unauthorized intruder 160 are attendees of the conference calling system 100. In another embodiment, less than or more than three participants are connected to the conference calling system 100.

In order to connect to the conference calling system 100, the participants 130, 140, and 150 use a reservationless bridge. The bridge setup is dynamic, wherein a call-in telephone number and a passcode from the conference moderator 120 are sufficient to begin the conference call. The participants 130, 140, and 150 have the same passcode (i.e., Passcode A), which is different from the passcode of the conference moderator 120 (i.e., Passcode Z). In another embodiment of the invention, the participants 130, 140, and 150 have different passcodes (e.g., Passcodes A, B, and C, respectively). In one embodiment, the intruder 160 has the conference moderator 120's passcode (i.e., Passcode Z). In another embodiment, the intruder 160 utilizes a participant's passcode (i.e., Passcode A, B, or C, depending on how passcodes are assigned) to connect to the conference calling system 100.

The conference system administer 110 configures the conference calling system 100 and assures its operation. These functions are embodied in the teleconference service provider (not shown). However, in one embodiment, these functions are delegated to the purchaser of the conference calling system 100. In another embodiment, an automatic monitoring system is utilized to configure the conference calling system 100 and assures its operation.

Having the conference moderator 120's passcode, the intruder 160 can either enter a conference call as an attendee during a legitimate meeting; or, the intruder 160 can establish an illegitimate meeting between himself and other intruders. In the fraud scenario illustrated in FIG. 1, the conference call was already in-process when the conference moderator 120 connected to the conference calling system 100. Without the fraud detection methodologies and systems herein, the conference calling system 100 does not inform the conference moderator 120 that another individual had previously started the conference call. Thus, the conference moderator 120 is not aware of the fraud by the intruder 160.

In one example of fraud, the intruder 160 connects to the conference calling system and waits until a conference call begins. This allows the intruder 160 to obtain information during the conference call. The intruder 160 is also allowed to use the conference calling system for other purposes after the moderator 120 and participants 130-150 disconnect from the conference calling system, for example, holding another conference call by sharing the passcode with others.

An embodiment of the invention includes a method to detect that an attendee of a conference call has entered a moderator passcode from a device or telephone number that has not been pre-registered in the moderator's profile, followed by the performance of validation actions and/or alerting of fraudulent activity. Thus, the initial act of fraud is prevented by establishing pre-registration of authorized devices and additional validations that ensure that only the registered moderator is able to enter the conference call. The method also denies intruders access to the conference calling system and logs reports for future action.

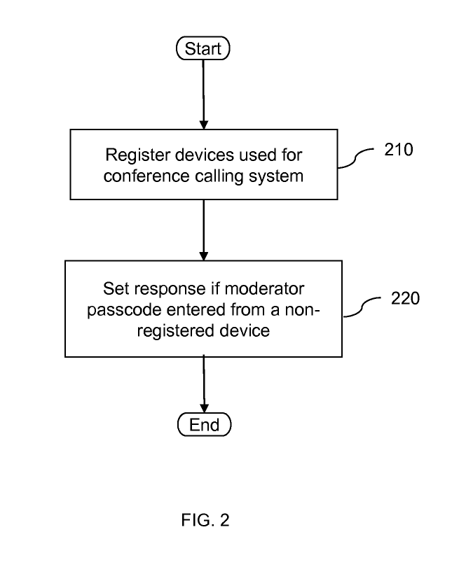

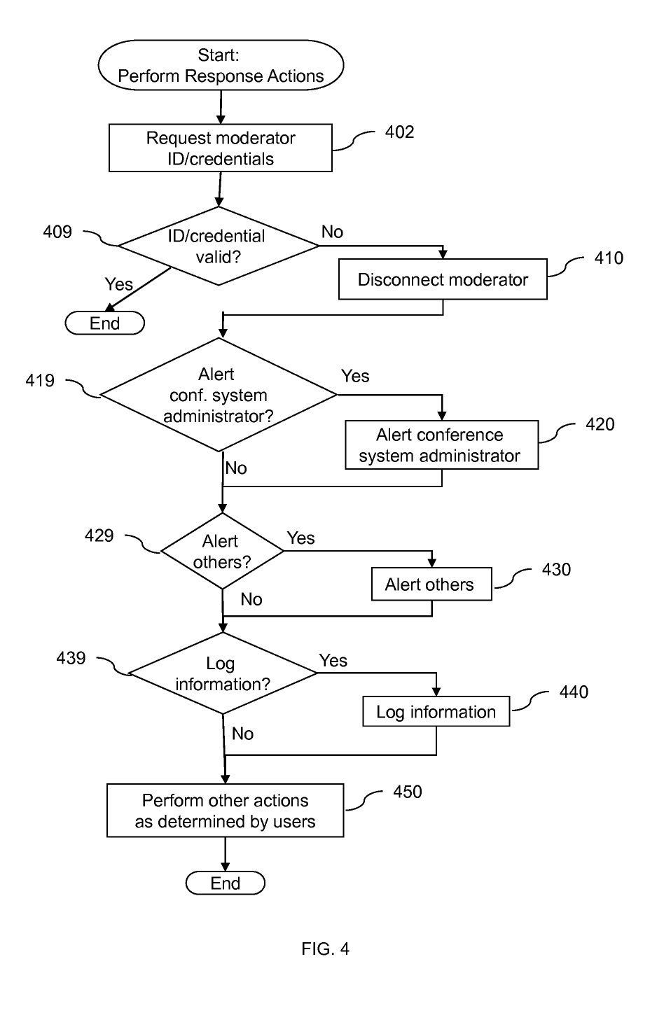

FIG. 2 illustrates a preparation phase according to an embodiment of the invention, wherein an indicator is set up which the conference calling system uses if the moderator passcode is entered from a non-registered device. In at least one embodiment, pre-registration of authorized device(s) is performed by the moderator during the preparation phase (i.e., prior to the initiation of the conference call). More specifically, the moderator registers the authorized device (210) by calling the conference calling system, wherein the conference calling system obtains the telephone number of the moderator's device (e.g., via a caller-identification system) and/or obtains an identifier of the moderator's device (e.g., information from a subscriber identity module (SIM) card). In another embodiment of the invention, the moderator registers the device by entering information regarding the device through a web site. In another embodiment, pre-registration of authorized device(s) is performed by a system administrator and/or the participants of the conference call during the preparation phase. Response action(s) are also set up by the moderator during the preparation phase to identify the action(s) to be performed (e.g., notify conference system administrator) if the moderator passcode is entered from an unauthorized device (220), as more fully described below with reference to FIG. 4. In another embodiment, a system administrator sets up the response actions during the preparation phase.

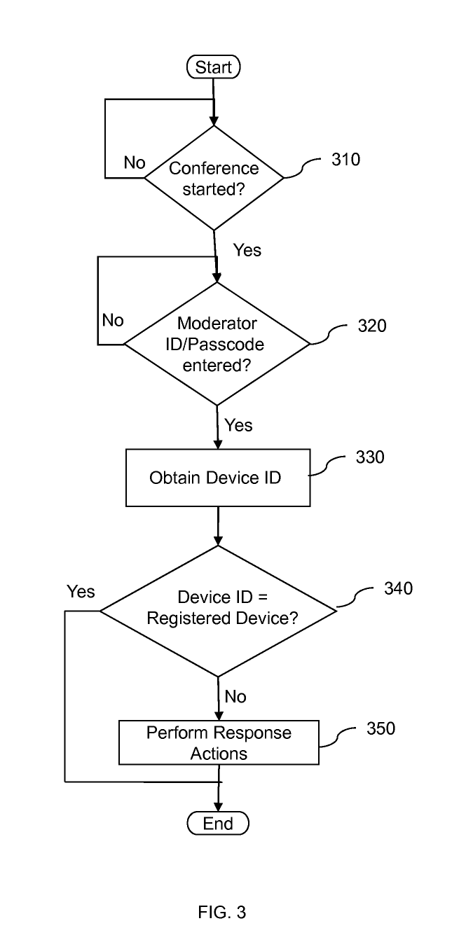

FIG. 3 is a flow diagram illustrating a method for determining whether a moderator passcode was entered from a pre-registered device according to an embodiment of the invention. More specifically, the method determines whether the conference call has started (310) and whether a moderator ID and/or passcode has been entered into the conference calling system (320). If a moderator ID and/or passcode has been entered, a device ID (e.g., telephone number, SIM card) is obtained from the device utilized to enter the moderator ID and/or passcode (330).

The method determines whether the obtained device ID matches a device ID of a registered device (340). As discussed above with reference to FIG. 2, at least one embodiment of the invention obtains the telephone number of the moderator's device (e.g., via a caller-identification system) when the moderator calls the conference calling system during the preparation phase. In an alternative embodiment of the invention, devices of at least one of the participants are also registered in the preparation phase; and, the method determines whether the obtained device ID matches a device ID of a registered device of a participant.

If the obtained device ID does not match the device ID of a registered device, response actions are performed (350), as described more fully below with reference to FIG. 4. If the obtained device ID matches the device ID of a registered device, the conference call is allowed to continue. After the response actions are performed or the conference call is allowed to continue, the conference call is ended.

FIG. 4 is a flow diagram illustrating a method for performing response actions according to an embodiment of the invention. In alternative embodiments, one or more of the response actions illustrated in FIG. 4 are omitted, dependent on the configuration as determined in the preparation phase. As described below, in at least one embodiment, the response actions illustrated in FIG. 4 are performed by a processor connected to an electronic database and a receiver.

The method requests additional moderator identification and/or credentials from the person who has entered the moderator ID/passcode from the device that has not been registered (402). The moderator identification includes the moderator's corporate employee number and/or ID badge number. The credentials may include, for example, at least one of the moderator's home telephone number, home address, mobile telephone number, e-mail address, office telephone number, office address, and secret question(s) entered when the moderator was assigned the moderator passcode(s) (e.g., pet's name, date of birth, mother's maiden name). The selection of the credential(s) is determined by the administrators of the conference calling system and/or the users of the conference calling system.

The conference calling system determines whether the information entered by the person who entered the moderator ID/passcode from the unregistered device matches the actual moderator identification and/or credentials (409). In at least one embodiment, the actual moderator identification and/or credentials are obtained from the true moderator (i.e., the person assigned the moderator passcode) during the preparation phase. If the additional moderator identification and/or credentials are valid, then additional response actions are not performed. If the additional moderator identification and/or credentials are not valid, then the processor of the conference calling system automatically disconnects the person who entered the moderator ID/passcode from the un-registered device from the conference calling system (410).

The processor of the conference calling system determines whether to send an alert to the conference system administrator (419). If the conference system administrator is alerted by the processor (420), further actions are automatically or manually performed by the conference system administrator. In at least one embodiment of the invention, such actions are setup prior to initiation of the conference call (e.g., during the preparation phase). The conference system administrator actions include monitoring for additional occurrences where a moderator ID and/or passcode has been entered through an un-registered device, monitoring for occurrences where additional moderator identification and/or credentials are not valid, terminating the conference call, and/or blocking the account from further usage (i.e., voiding the moderator ID and/or passcode). For example, in at least one embodiment, a passcode is voided or temporarily disabled after 5 unsuccessful attempts to access the conference calling system in a 24 hour period.

The processor in at least one embodiment also determines whether to alert others (429). The processor alerts others (430) by sending an alert to at least one of the true moderator, administrative personnel of the conference calling system provider, and security personnel employed by the true moderator's company (or government agency or religious organization) who is responsible for tracking risks and investigating fraud across the company. The alert indicates that a moderator ID and/or passcode has been entered through an un-registered device. In at least one embodiment, the alerts include a time stamped e-mail, text message, instant message, facsimile, and/or other form of communication.

Furthermore, the processor determines whether to log information for future reference and reporting into, for example, a report database (439). The processor logs information (440) by saving a report of the occurrence in a database. The report includes, for example, the device ID of the device requesting access to the conference calling system, the device ID of the moderator's device, the moderator's ID and/or passcode, additional moderator identification and/or credentials entered by the person requesting access to the conference calling system, the actual identification and/or credentials of the true moderator, the telephone numbers of the attendees that called into the conference calling system (obtained from a caller-identification system), the time and date that moderator ID/passcodes were entered into the conference calling system, and/or a detailed description of the response action(s) taken, e.g., time, date, and identification of persons who were sent an alert. Information in the report is utilized to identify trends, track moderator ID and/or passcode usage, and/or for detailed review by the conference system administrator and/or personnel within the true moderator's company. For example, in at least one embodiment, the conference system administrator compares reports that have been collected over time in order to identify trends, such as the number of times a moderator passcode was entered from a non-registered device and/or the time and day that a non-registered device frequently requests access to the conference calling system.

The processor also performs other actions as determined by users of the conference calling system (450). For example, in at least one embodiment, the conference calling system automatically captures an audio recording of the conference call when a non-registered device requests access to the conference calling system.

In an alternative embodiment, the response actions are performed in another order, e.g., the conference system administer is alerted prior to disconnecting the un-registered device. In another alternative embodiment, response actions are performed when the obtained device ID does not match a device ID of a registered device of a participant. Such response actions include, for example, comparing identification and/or credentials obtained from the person requesting access to the conference calling system from the un-registered device to stored identification and/or credentials of the participants, voiding one or more of the participant passcodes, and alerting others, as discussed previously.

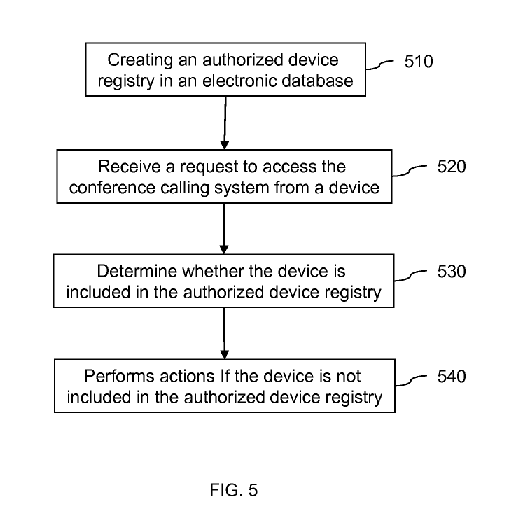

FIG. 5 is a flow diagram illustrating a method for detecting fraudulent use in a conference calling system according to an embodiment of the invention. An authorized device registry is created in an electronic database (510), wherein the authorized device registry identifies one or more authorized devices permitted to access the conference calling system. In at least one embodiment, the authorized device registry also includes the device identification numbers of the authorized devices. In at least one embodiment, the telephone number associated with an authorized device is obtained via a caller-identification system when the authorized device contacts the conference calling system. In another embodiment, information regarding an authorized device is obtained from a subscriber identity module (SIM) card of the authorized device, a moderator of the conference calling system, and/or an administrator of the conference calling system. For example, pre-registration of authorized devices is performed by the moderator during the preparation phase (i.e., prior to the initiation of the conference call). As discussed above, in at least one embodiment, response actions are also set up by the moderator during the preparation phase to identify the actions to be performed if a passcode is entered from an unauthorized device.

A request to access the conference calling system is received from a device (520). In at least one embodiment, the request to access the conference calling system includes either a moderator or participant passcode. In at least one embodiment, user information (also referred to herein as “first information”) is obtained from the person assigned the passcode. In at least one embodiment, the user information is input into an electronic database by the system administrator, moderator, and/or another employee of the user's company, wherein the user information is subsequently retrieved from the database for validation purposes. The user information includes an employee number, an identification badge number, a home telephone number, a home address, a mobile telephone number, an e-mail address, an office telephone number, an office address, and/or answer(s) to security question(s) entered by the person assigned the passcode. In at least one embodiment, user information is obtained from attendees of the conference call during the preparation phase. In another embodiment, an identification number is obtained from the device (also referred to herein as the “call-in device identification number”).

A processor determines whether the device is included in the authorized device registry (530). In at least one embodiment, the processor determines whether the call-in device identification number of the device matches the authorized device identification number of an authorized device. If the device is included in the authorized device registry, the device is granted access to the conference calling system. If the device is not included in the authorized device registry; however, actions (also referred to herein as “response actions”) are performed by the processor (540).

In at least one embodiment, devices having the call-in device identification number of a device not listed in the authorized device registry are barred from accessing the conference calling system. In another embodiment, validation information (also referred to herein as “second information”) is obtained from the person requesting access to the conference calling system from the device. The user information is compared to the validation information to determine whether the user information matches the validation information. If the user information does not match the validation information, an alert indicating that an unauthorized device has requested access to the conference calling system is sent to the person assigned the passcode. In at least one embodiment, the alert is also sent in addition or alternatively to the person assigned the passcode to an administrator of the conference calling system, participants of the conference call, and/or a security personnel of the teleconference provider and/or at least one company employing a participant of the teleconference call. In at least one embodiment, the alerts include a time stamped e-mail, text message, instant message, facsimile, and/or other form of communication. If the validation information does not match the user information, actions are performed by the processor.

In at least one embodiment, further actions include allowing the administrator to enter the conference call, terminating the conference call, voiding the passcode, and barring the device from access to the conference calling system. In another embodiment, a report is generated and stored if the device is not included in the authorized device registry. The report includes the passcode, the total number of passcodes entered into the conference calling system, the total number of moderator passcodes entered into the conference calling system, the time and date when the request to access the conference calling system was received, the call-in device identification number of the device, authorized device identification numbers, and/or the actions performed (including the user and validation information).

Information in the report is utilized to identify trends, track moderator ID and/or passcode usage, and/or for detailed review by the conference system administrator and/or personnel within the true moderator's company. For example, in at least one embodiment, the conference system administrator compares reports that have been collected over time in order to identify trends, such as the number of times a moderator passcode was entered from a non-registered device and/or the time and day that a non-registered device frequently requests access to the conference calling system.

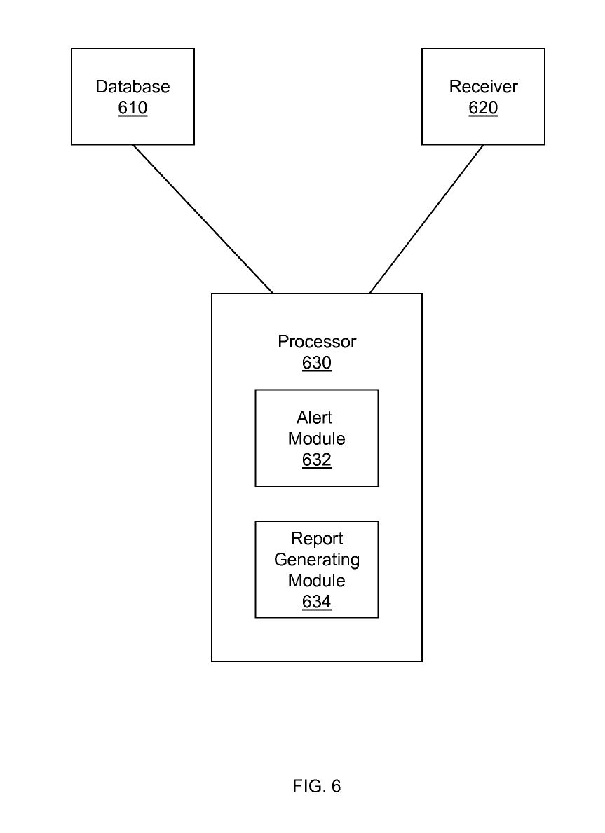

FIG. 6 illustrates a system for detecting fraudulent use in a conference calling system according to an embodiment of the invention. An electronic database 610 includes an authorized device registry that identifies one or more authorized devices permitted to access the conference calling system. A receiver 620 receives requests to access the conference calling system from devices. A processor 630 is operatively connected to the electronic database 610 and the receiver 620, wherein the processor 630 determines whether devices sending requests to access the conference calling system are included in the authorized device registry. If a device requesting access to the conference calling system is not included in the authorized device registry, the processor 630 performs action(s).

For example, the performed action(s) includes the processor 630 includes an alert module 632 that sends an alert to the administrator of the conference calling system, attendees of the conference call, and/or a security personnel, wherein the alert indicates that an unauthorized device has requested access to the conference calling system. In another example, the processor 630 includes a report generating module 634 that generates and stores a report in the electronic database 610 if the requesting device is not included in the authorized device registry. In at least one embodiment, the report includes passcodes of the conference calling system, the total number of passcodes entered, the time and date when the request to access the conference calling system was received from the requesting device, the call-in device identification number of the requesting device, the authorized device identification numbers of the authorized devices, and the actions performed by the processor 630. In another embodiment of the invention, the alert module 632 and report generating module 634 are outside of the processor 630.

Accordingly, an embodiment of the invention includes systems and methodologies to investigate potential fraudulent activity on conference calling systems. The occurrence of a potential fraudulent condition is identified, such that rapid response actions may be taken. The embodiments of the invention can save thousands of dollars in fraudulent toll charges. Moreover, the ability to identify fraudulent activity can prevent the loss of information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

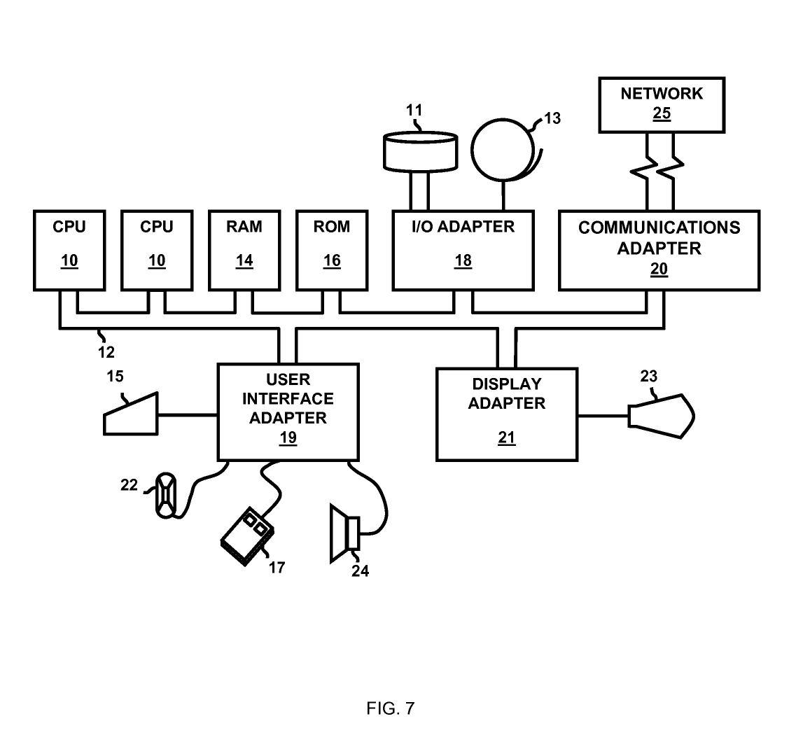

Referring now to FIG. 7, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for detecting fraudulent use in a conference calling system, said method including:
creating an authorized device registry in an electronic database, the authorized device registry including identification of at least one authorized device permitted to access the conference calling system;
receiving a request to access the conference calling system from a device;
determining whether the device is included in the authorized device registry with a processor; and
performing actions with the processor if the device is not included in the authorized device registry.

2. The method according to claim 1, further including permitting the device to access the conference calling system if the device is included in the authorized device registry.

3. The method according to claim 1, wherein said creating of the authorized device registry includes obtaining an authorized device identification number of the at least one authorized device,
wherein said receiving of the request to access the conference calling system from the device includes obtaining a call-in device identification number of the device, and
wherein said determining whether the device is included in the authorized device registry includes determining whether the call-in device identification number of the device matches the authorized device identification number of the at least one authorized device.

4. The method according to claim 3, further including barring access to the conference calling system by devices having the call-in device identification number of the device.

5. The method according to claim 1, wherein said identification of the at least one authorized device permitted to access the conference calling system includes at least one of:
obtaining a telephone number associated with the at least one authorized device via a caller-identification system when the at least one authorized device contacts the conference calling system,
obtaining information from a subscriber identity module (SIM) card of the at least one authorized device, and
obtaining information regarding the at least one authorized device from at least one of a moderator of the conference calling system and an administrator of the conference calling system.

6. The method according to claim 1, wherein the request to access the conference calling system includes a passcode,
wherein said method further includes obtaining first information from a person assigned the passcode, and
wherein said performing of the actions includes obtaining second information from a person who sent the request to access the conference calling system from the device, and determining whether the first information matches the second information.

7. The method according to claim 6, wherein said performing of the actions includes, sending an alert to the person assigned the passcode if the first information does not match the second information, the alert indicating that an unauthorized device has requested access to the conference calling system.

8. The method according to claim 6, wherein the first information includes at least one of an employee number, an identification badge number, a home telephone number, a home address, a mobile telephone number, an e-mail address, an office telephone number, an office address, and at least one answer to at least one security question entered by the person assigned the passcode.

9. The method according to claim 1, wherein said performing of the actions includes sending an alert to at least one of an administrator of the conference calling system, a person assigned a passcode, participants of a conference call of the conference calling system, and at least one security personnel, the alert indicating that an unauthorized device has requested access to the conference calling system.

10. The method according to claim 1, wherein said performing of the actions includes at least one of permitting an administrator of the conference calling system to enter a conference call of the conference calling system, terminating the conference call, voiding a passcode, and barring the device from access to the conference calling system.

11. The method according to claim 1, wherein said performing of the actions includes generating and storing a report if the device is not included in the authorized device registry, where the report includes at least one of a passcode, a total number of passcodes entered into the conference calling system, a total number of moderator passcodes entered into the conference calling system, a time and date when the request to access the conference calling system was received from the device, a call-in device identification number of the device, an authorized device identification number of the at least one authorized device, and the actions performed.

12. The method according to claim 11, wherein the actions include first information from a person assigned the passcode, and second information from at least one person who has entered the passcode into the conference calling system.

13. A system for detecting fraudulent use in a conference calling system, said system including:
an electronic database including an authorized device registry, the authorized device registry including identification of at least one authorized device permitted to access said conference calling system;
a receiver for receiving a request to access said conference calling system from a device;
a processor operatively connected to said electronic database and said receiver,
said processor determines whether the device is included in the authorized device registry, and
said processor performs actions if the device is not included in the authorized device registry.

14. The system according to claim 13, wherein said processor permits the device to access said conference calling system if the device is included in the authorized device registry.

15. The system according to claim 13, wherein said electronic database includes at least one authorized device identification number for each authorized device,
wherein said receiver receives a call-in device identification number of the device, and
wherein said processor determines whether the call-in device identification number of the device matches the authorized device identification number of the at least one authorized device.

16. The system according to claim 13, wherein the electronic database includes at least one of:
a telephone number associated with the at least one authorized device obtained via a caller-identification system when the at least one authorized device contacts said conference calling system,
information from a subscriber identity module (SIM) card of the at least one authorized device, and
information regarding the at least one authorized device obtained from at least one of a moderator of said conference calling system and an administrator of said conference calling system.

17. The system according to claim 13, wherein said receiver receives a passcode, and wherein said processor determines whether first information obtained from a person assigned the passcode matches second information obtained from a person who sent the request to access said conference calling system from the device.

18. The system according to claim 17, wherein said processor includes an alert module, said alert module sends an alert to the person assigned the passcode if the first information does not match the second information, the alert indicating that an unauthorized device has requested access to said conference calling system.

19. The system according to claim 17, wherein the first information includes at least one of an employee number, an identification badge number, a telephone number, a home address, an e-mail address, an office address, and at least one answer to at least one security question entered by the person assigned the passcode.

20. The system according to claim 13, wherein said processor includes an alert module, said alert module sends an alert to at least one of an administrator of said conference calling system, a person assigned a passcode, participants of a conference call of said conference calling system, and at least one security personnel, the alert indicating that an unauthorized device has requested access to said conference calling system.

21. The system according to claim 13, wherein said processor does at least one of permits an administrator of said conference calling system to enter a conference call of said conference calling system, terminates the conference call, voids a passcode, and bars the device from access to said conference calling system.

22. The system according to claim 13, further including a report generating module for generating and storing a report in said electronic database if the device is not included in the authorized device registry, where the report includes at least one of a passcode, a total number of passcodes entered into said conference calling system, a total number of moderator passcodes entered into said conference calling system, a time and date when the request to access said conference calling system was received from the device, a call-in device identification number of the device, an authorized device identification number of the at least one authorized device, and the actions performed.

23. The system according to claim 22, wherein the actions include first information from a person assigned the passcode, and second information from at least one person who has entered the passcode into said conference calling system.

24. A computer program product for detecting fraudulent use in a conference calling system, said computer program product including:
a computer readable storage medium;
first program instructions to create an authorized device registry in an electronic database, the authorized device registry including identification of at least one authorized device permitted to access the conference calling system;
second program instructions to receive a request to access the conference calling system from a device;
third program instructions to determine whether the device is included in the authorized device registry with a processor; and
fourth program instructions to performing actions with the processor if the device is not included in the authorized device registry,
wherein said first program instructions, said second program instructions, said third program instructions, and said fourth program instructions are stored on said computer readable storage medium.

25. The computer program product according to claim 24, wherein said first program instructions obtain an authorized device identification number of the at least one authorized device,
wherein said second program instructions obtains a call-in device identification number of the device, and
wherein said third program instructions determines whether the call-in device identification number of the device matches the authorized device identification number of the at least one authorized device.
